(19) United States
(12) Patent Application Publication
(10) Pub. No.: US 2015/0321915 A1
(43) Pub. Date: Nov. 12, 2015

(54) PROCESS AND SYSTEM FOR PRODUCTION OF DICHLORINE

(71) Applicant: Dow Global Technologies LLC, Midland, MI (US)

(72) Inventors: Eric E. Stangland, Midland, MI (US); Daniel A. Hickman, Midland, MI (US); Mark E. Jones, Midland, MI (US); Simon G. Podkolzin, Midland, MI (US); Shawn D. Feist, Midland, MI (US)

(73) Assignee: DOW GLOBAL TECHNOLOGIES LLC, Midland, MI (US)

(21) Appl. No.: 14/802,032

(22) Filed: Jul. 17, 2015

Related U.S. Application Data
(62) Division of application No. 13/096,556, filed on Apr. 28, 2011.
(60) Provisional application No. 61/328,925, filed on Apr. 28, 2010.

(51) Int. Cl. C01B 7/04

(52) U.S. Cl. CPC C01B 7/04

(57) ABSTRACT

The present disclosure provides a process and a system for producing dichlorine (Cl₂).

### PRIORITY INFORMATION

This application is a Divisional Application of U.S. Non-Provisional application Ser. No. 13/096,556, filed on Apr. 28, 2011 and published as U.S. Publication No. 2011/0268648 on Nov. 3, 2011, which claims priority to U.S. Provisional Application 61/328,925 filed Apr. 28, 2010, the specification of which is incorporated herein by reference.

### TECHNICAL FIELD

The present disclosure relates generally to dichlorine and more specifically to a process and a system for the production of dichlorine.

### BACKGROUND

Traditional Deacon chemistry for the oxidative conversion of hydrochloric acid (HCl) to dichlorine (Cl₂) is equilibrium limited. At lower temperatures, where high conversions of dichlorine are the most favored, the catalytic kinetics of the Deacon reaction over most conventional catalyst systems, such as those composed of copper or ruthenium, are too slow, while at high temperature where significant reaction can occur the formation of dichlorine is equilibrium limited.

### SUMMARY

Embodiments of the present disclosure provide a process and system for the production of dichlorine (Cl₂). For the various embodiments, the process for producing dichlorine includes reacting a rare-earth metal oxy-chloride with hydrochloric acid (HCl) at a first temperature during a chlorination stage of the process to form a rare-earth metal chloride and water (H₂O); removing the water from the rare-earth metal chloride; and reacting the rare-earth metal chloride with oxygen (O₂) at a second temperature greater than the first temperature during an oxidation stage of the process to form dichlorine and the rare-earth metal oxy-chloride. For the various embodiments, the rare-earth metal oxy-chloride from the oxidation stage can be used in the chlorination stage of the process. For the various embodiments, an example of the rare-earth metal oxy-chloride is lanthanum oxychloride (LaOCl) and an example of the rare-earth metal chloride is lanthanum trichloride (LaCl₃).

For the various embodiments, removing water from the rare-earth metal chloride includes purging the rare-earth metal chloride with an inert gas to remove the water. Water removed from the rare-earth metal chloride according to the present disclosure can be primary water and/or residual water, as defined herein. Embodiments of the present disclosure also allow for passing the hydrochloric acid over and/or through the rare-earth metal oxy-chloride in the chlorination stage and passing oxygen over and/or through the rare-earth metal chloride in the oxidation stage. In certain embodiments, the rare-earth metal chloride can be conveyed from the chlorination stage to the oxidation stage, and the rare-earth metal oxy-chloride can be conveyed from the oxidation stage to the chlorination stage. For the various embodiments, the rare-earth metal oxy-chloride and the rare-earth metal chloride remain in a solid, non-liquid state at the first temperature and at the second temperature.

For the various embodiments, the system to produce dichlorine can include a chlorination reactor having a first inlet and a first outlet; a rare-earth metal oxy-chloride in the chlorination reactor, where HCl moving between the first inlet and the first outlet of the chlorination reactor reacts with the rare-earth metal oxy-chloride at a first temperature to form a rare-earth metal chloride and water; an oxidation reactor containing the rare-earth metal chloride and having a second inlet and a second outlet, where oxygen moving between the second inlet and the second outlet of the oxidation reactor reacts with the rare-earth metal chloride at a second temperature greater than the first temperature to form the rare-earth metal oxy-chloride and dichlorine; a conduit connecting the chlorination reactor and the oxidation reactor, where the rare-earth metal chloride from the chlorination reactor moves through the conduit to the oxidation reactor and the rare-earth metal oxy-chloride in the oxidation reactor moves through the conduit to the chlorination reactor; a purge system that purges water from the rare-earth metal chloride moving through the conduit from the chlorination reactor to the oxidation reactor; and a heater associated with each of the chlorination reactor and the oxidation reactor, where the heater at least partially heats the rare-earth metal chloride in the chlorination reactor to the first temperature and at least partially heats the rare-earth metal oxy-chloride in the oxidation reactor to the second temperature.

For the various embodiments, the rare-earth metal is a lanthanoid. In one embodiment, the lanthanoid is lanthanum. For the various embodiments, the catalyst does not include copper (Cu). For the various embodiments, the catalyst does not include ruthenium (Ru).

### DEFINITIONS

As used herein “dichlorine” is defined as chlorine gas (Cl₂) at standard temperature and pressure of 0° C. and an absolute pressure of 100 kPa (IUPAC).

As used herein, “° C.” is defined as degrees Celsius.

As used herein, “KPa” is defined as a kilopascal unit of pressure.

As used herein, “ambient pressure” is defined as the pressure of the external environment in which the process and/or system of the present disclosure is operated.

As used herein, “primary water” is defined as free water (in a vapor state or a liquid state) that is not bound to and/or associated with the rare-earth metal catalyst of the present disclosure.

As used herein, “residual water” is defined as water that is bound to and/or associated with the rare-earth metal catalyst either as adsorbed molecular water or water in the form of bound hydroxyl groups to the surface of the rare-earth metal catalyst of the present disclosure.

As used herein, “a,” “an,” “the,” “at least one,” and “one or more” are used interchangeably. The terms “comprises” and variations thereof do not have a limiting meaning where these terms appear in the description and claims. Thus, for example, a system having a chlorination reactor can be interpreted to mean that the system includes “one or more” chlorination reactors.

As used herein, the term “and/or” means one, more than one, or all of the listed elements.

Also herein, the recitations of numerical ranges by endpoints include all numbers subsumed within that range (e.g., 1 to 5 includes 1, 1.5, 2, 2.75, 3, 3.80, 4, 5, etc.).

### BRIEF DESCRIPTION OF DRAWINGS

FIG. 1 provides a schematic of a system for producing dichlorine according to an embodiment of the present disclosure.

FIG. 2 provides a schematic of a system for producing dichlorine according to an embodiment of the present disclosure.

FIG. 3 provides a schematic of a system for producing dichlorine according to an embodiment of the present disclosure.

FIG. 4 provides a plot of HCl conversion as a function of time according to the present disclosure.

FIG. 5 provides a plot of HCl conversion as a function of rare-earth catalyst stoichiometry according to the present disclosure.

FIG. 6 provides a schematic of a system for producing dichlorine according to an embodiment of the present disclosure.

FIG. 7 provides a normalized chlorine evolution results from temperature-programmed oxidation of rare-earth metal catalysts according to the present disclosure.

### DETAILED DESCRIPTION

Embodiments of the present disclosure provide a process for producing dichlorine (Cl₂) and a system to produce dichlorine. The embodiments of the present disclosure overcome the thermodynamics of the Deacon reaction by using a rare-earth catalyst in a two-stage process. Embodiments of the present disclosure also overcome the limitations of copper-based catalytic oxidation of hydrochloric acid (HCl) to dichlorine as the rare-earth catalyst of the present disclosure needs no support, is more stable at high temperatures and is less prone to deactivation, relative to copper-based catalysts.

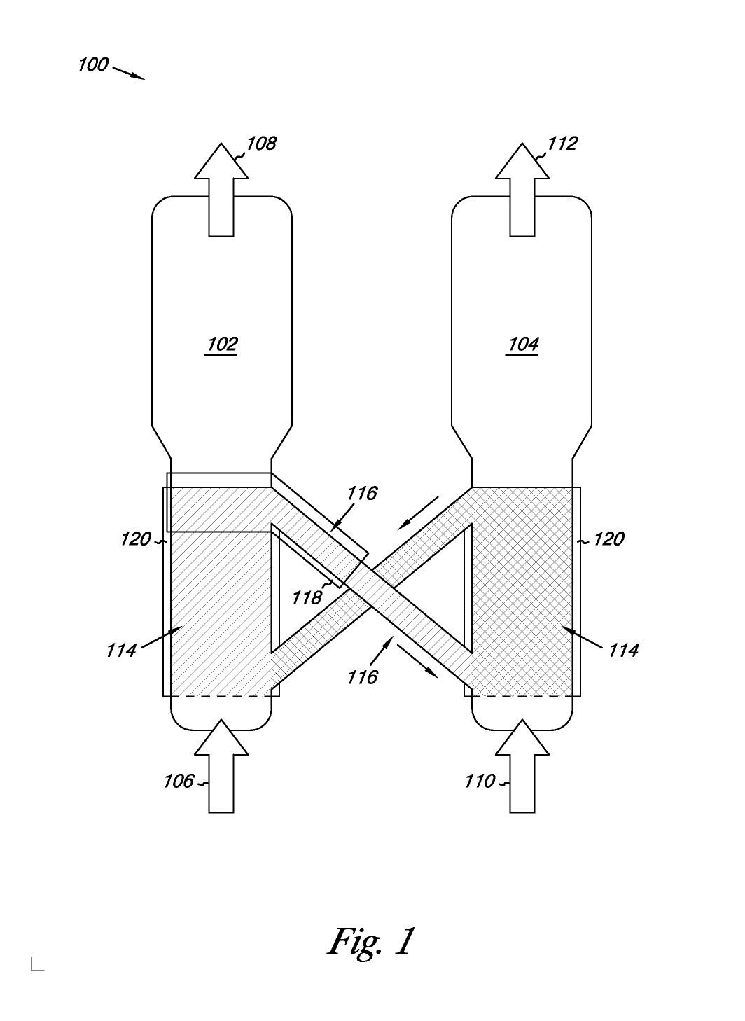

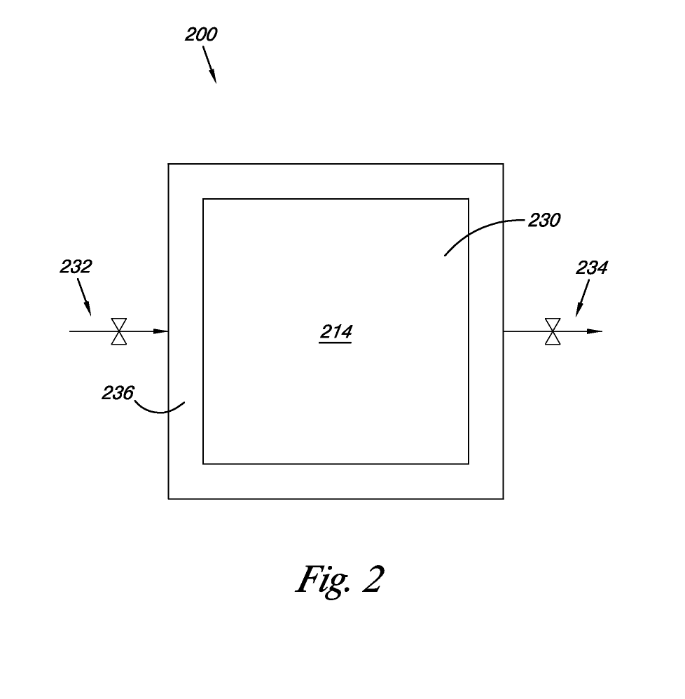

The figures herein follow a numbering convention in which the first digit or digits correspond to the drawing figure number and the remaining digits identify an element or component in the drawing. Similar elements or components between different figures may be identified by the use of similar digits. For example, 110 may reference element “10” in FIG. 1, and a similar element may be referenced as 210 in FIG. 2. As will be appreciated, elements shown in the various embodiments herein can be added, exchanged, and/or eliminated so as to provide additional embodiments of the present disclosure. In addition, as will be appreciated the proportion and the relative scale of the elements provided in the figures are intended to illustrate the embodiments of the present invention, and should not be taken in a limiting sense.

Dichlorine can be produced by a catalytic oxidation of HCl with oxygen via what is called the Deacon reaction:

2HCl+1/2O₂→H₂O+Cl₂

Copper-based catalysts have been used in the Deacon reaction, but they suffer from a variety of drawbacks. These include limited activity, rapid deactivation due to volatilization of copper chloride above about 400° C. when the temperature is raised to overcome activity limitations, and corrosion problems due to the presence of unreacted HCl with the product H₂O. If fact, regardless of what other metal may be envisioned to catalyze the Deacon reaction, a one-stage process suffers from the limitations that thermodynamics imposes on the conversion of HCl for this reaction at temperatures of relevant chemical kinetics.

Two stage reactor systems using copper-based catalyst have also been suggested in an attempt to improve conversion of the HCl to dichlorine while minimizing deactivation of the copper-based catalyst. Such systems usually take the form of dual reactor systems, where one of the two reactors is operated at a temperature that is higher than the other reactor. In some embodiments, the use of these two stage reactor systems subdivides the Deacon reaction into two component reaction stages of (1) Chlorination and (2) Oxidation, where the chlorination reaction (1) is conducted at the lower-temperature and the oxidation reaction (2) is conducted at the higher-temperature:

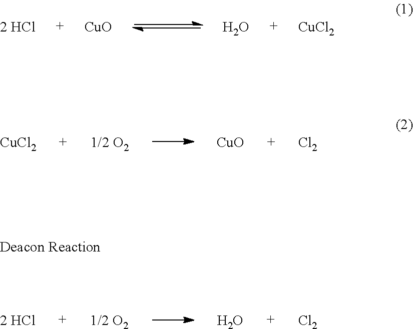

Even with the two stage reactor systems, copper-based catalysts continue to present performance issues in converting HCl to dichlorine. For example, copper-based catalysts require a support, which necessarily minimizes the amount of the actual catalyst (i.e., the copper-based compound) for a given amount of the catalyst. Copper-based catalysts also use promoters in an attempt to improve the catalytic activity of the catalyst. Also, copper-based catalysts can be prone to catalyst deactivation due to copper chloride volatilization. As a result, the extent of either reaction (1) and/or (2) is limited. Copper-based catalysts can also cause issues of corrosion due to the formation of a liquid copper chloride melt. The two stage reactor systems also continue to suffer from HCl contamination of the chlorine product due to HCl liberation during dechlorination. As a result, HCl remains an unwanted by-product that must be removed from the production stream of dichlorine.

Embodiments of the present disclosure can overcome these performance issues found in converting HCl to dichlorine with copper-based catalysts. In contrast to using copper, embodiments of the present disclosure use a rare-earth catalyst. For the various embodiments, the rare-earth catalyst of the present disclosure can allow for operating temperatures for both a chlorination stage and an oxidation stage that are significantly higher than those used with copper-based catalysts. For the various embodiments, the rare-earth catalyst used in the embodiments of the present disclosure has a higher thermal stability as compared to the copper-based catalysts. This allows for, among other things, a shift in the equilibrium that can be favorable to the production of dichlorine during the oxidation phase of the two-step reaction.

In addition, the rare-earth catalysts used in the embodiments of the present disclosure do not require a support as is the case with copper-based catalysts. For the various embodiments, this can allow for a higher loading density of the rare-earth catalyst as compared to the copper-based and/or ruthenium-based catalysts in a reactor. In addition to a higher loading density, the use of the rare-earth catalyst may allow for a wider range of operating conditions (e.g., higher operating temperatures), which may provide accompanying improvements in the production of dichlorine from HCl relative a copper-based catalysis system.

For the various embodiments, the process for producing dichlorine according to the present disclosure includes reacting the rare-earth catalyst in the form of a rare-earth metal oxy-chloride with HCl at a first temperature during a chlorination stage of the process to form rare-earth metal chloride and water (H₂O). For the various embodiments, the water is removed from the rare-earth metal chloride, and the rare-earth metal chloride is reacted with oxygen (O₂) at a second temperature greater than the first temperature during an oxidation stage of the process to form the dichlorine (Cl₂) and the rare-earth metal oxy-chloride. Water removed from the rare-earth metal chloride according to the present disclosure can be primary water and/or residual water, as defined herein. The rare-earth metal oxy-chloride can then be used again in the chlorination stage of the process as the cycle of producing the dichlorine is repeated. For the various embodiments, the rare-earth metal oxy-chloride and the rare-earth metal chloride remain in a solid, non-liquid state at the first temperature and the second temperature.

For the various embodiments, the rare-earth catalyst of the present disclosure can include oxy-chloride and/or chloride forms of Lanthanides, which include elements with atomic numbers 56 through 71 according to IUPAC Periodic Table of the Elements version dated Jun. 22, 2007 (i.e., Ba, La, Ce, Pr, Nd, Pm, Sm, Eu, Gd, Tb, Dy, Ho, Er, Tm, Yb and Lu). The rare-earth catalysts of the present disclosure do not include copper (Cu). The rare-earth catalysts of the present disclosure do not include ruthenium (Ru).

For the various embodiments, the rare-earth catalyst of the present disclosure can be cycled between an oxidized state (e.g., the oxy-chloride state) and a chlorided state (e.g., the chloride state) in the process and the system of the present disclosure. For example, when lanthanum (La) is selected as the rare-earth catalyst it can exist in a variety of oxy-chloride states and chloride states represented by the formula LaO_{(3-y)/2}Cl_{y} where y preferably equals 1 for the oxy-chloride state (LaOCl) to 3 for the chloride state (LaCl₃). Intermediate hydrated states (residual water) of the lanthanum represented by the general formula LaO_{(3-y)}H_{(3-y)}Cl_{y} may exist in equilibrium with materials of the general formula LaO_{(3-y)/2}Cl_{y}. For instance, the oxy-chloride LaOCl can be in equilibrium with that material having residual water, represented by the formula LaO₂H₂Cl.

Lanthanides, for example lanthanum (La), have been found to interconvert between the rare-earth metal chloride state (LaCl₃) state and the rare-earth metal oxy-chloride state (LaOCl) or equivalent hydrated states in the presence of oxygen, HCl, and chlorine. The state of the rare-earth metal can be determined by the relative environment of dichlorine (or HCl) and O₂ (or H₂O) in this process. This process is also dictated by equilibrium, but can be overcome in flow reactors in a dynamic process. For example, the rare-earth metal chloride state (e.g., LaCl₃) can be converted to the rare-earth metal oxy-chloride state (e.g., LaOCl) in the presence of O₂, liberating Cl₂, and the LaOCl can be converted to LaCl₃ in the presence of HCl, liberating H₂O.

While these two states of the rare-earth catalyst are controlled by equilibrium when both oxidant and chlorine agents are present, the rare-earth catalyst can also be used as a chlorine and/or oxygen storage material. So, for example, “Deacon-like” reaction can be conducted in a two-stage process that splits the equilibrium limitations of the Deacon reaction, or the equilibrium of the material phases.

For example, embodiments of the present disclosure provide that the Deacon reaction can be split into two stages (a chlorination stage and an oxidation stage) that taken together convert a stream of HCl to dichlorine. For the various embodiments, splitting the Deacon reaction into two stages allows for the equilibrium found in each stage through the use of the rare-earth catalyst of the present disclosure to be used advantageously. For example, when the rare-earth catalyst is derived from lanthanum (La), the rare-earth catalyst can interconvert between the rare-earth metal chloride state (LaCl₃) and the rare-earth metal oxy-chloride state (LaOCl) in the presence of oxygen and chlorine according to the following chlorination stage (A) and oxidation stage (B) reactions:

LaOCl+2HCl<==>LaCl₃+H₂O (A)

LaCl₃+1/2O₂==>LaOCl+Cl₂ (B)

where reacting the lanthanum in the oxy-chloride state (LaOCl) with HCl during the chlorination stage (A) to converts it to the lanthanum in the chloride state (LaCl₃). For the various embodiments, the lanthanum in the chloride state produced in chlorination stage (A) is reacted with oxygen (O₂) in the oxidation stage (B) to convert the lanthanum in the chloride state to the lanthanum in the oxy-chloride state while liberating dichlorine. So, the net chemistry can be written as follows:

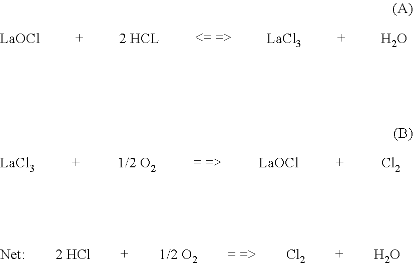

By splitting the Deacon reaction into the chlorination stage (A) and the oxidation stage (B) reactions, the conversion of each phase is no longer dictated by the equilibrium thermodynamic constraints of the system. The process limitations remaining are then the kinetic interconversion of the phases.

For the various embodiments, the water formed in the chlorination stage (A) is removed from the rare-earth metal chloride prior to the oxidation stage (B) reactions. This better ensures that the rare-earth metal remains in its chloride state for the subsequent oxidation stage (B) reaction, producing a dry dichlorine stream. So, for the various embodiments removing water from the rare-earth metal chloride can be accomplished by purging the rare-earth metal chloride with an inert gas. For the various embodiments, purging the water from the rare-earth metal chloride can be accomplished by passing an inert gas over and/or through the rare-earth metal chloride (e.g., LaCl₃) produced in chlorination stage (A). For the various embodiments, the inert gas can have a water content of less than 1 weight percent, preferably a water content of less than 0.5 weight percent, and most preferably a water content of less than 0.1 weight percent.

Examples of suitable inert gases include, but are not limited to, nitrogen gas (N₂), noble gases (e.g., such as helium), oxygen, methane and combinations thereof. In some embodiments, air and/or oxygen could be the preferred inert if the air temperature is sufficiently high enough as to dehydrate the rare-earth metal chloride, but sufficiently low enough as not to convert the rare-earth metal chloride to the rare-earth oxide. For the various embodiments, in addition to using the inert gas, it would also be possible to use other drying compounds (e.g., a solid desiccant and/or a liquid desiccant) that could help to dry the atmosphere surrounding the rare-earth metal chloride produced in chlorination stage (A), or dry the incoming inert gas stream before contacting the rare-earth metal chloride. In addition, the pressure of the environment surrounding the rare-earth metal chloride produced in chlorination stage (A) could also be changed (e.g., lowered) in an effort to enhance and/or maintain the rare-earth metal chloride produced in chlorination stage (A) in a dry state. Since the rare-earth metal chloride can exist in equilibrium with its hydrated state, the water content for the rare-earth metal chloride after the purge is defined as the level of water contained in the hydrated solid that at oxidation temperature limits water in the dichlorine stream to the preferred embodiment level during the oxidation state (B). For the various embodiments, the dichlorine gas produced in the oxidation state (B) can have a water content of less than 1 weight percent, preferably a water content of less than 0.5 weight percent, and most preferably a water content of less than 0.1 weight percent.

The rare-earth catalysts used in the embodiments of the present disclosure may or may not use a support. If a support is used, the support material can include, but is not limited to, silica, or alumina, zirconia, and titania, or mixtures thereof, among others compounds. For the various embodiments, forming the rare-earth catalyst with a support of silica, alumina, zirconia, titania, or mixtures thereof can be accomplished by impregnating a rare-earth salt(s) (e.g., a Lanthanide salts such as, for example, lanthanum chloride) into either the support of silica, alumina, zirconia, titania, or mixtures thereof. In an alternative embodiment, the rare-earth catalyst with a support can be formed by co-precipitation of the rare-earth salt(s) and the support compound. For the various embodiments, the rare-earth catalysts of the present disclosure can have greater than a 5 weight percent loading of a rare-earth metal on the support.

Preferably, the rare-earth catalysts of the present disclosure use the rare-earth metal that lies beneath the interface at which the catalytic activity occurs as the support. For the various embodiments, this allows for a greater chlorine storage capacity per weight of the catalyst relative copper-based catalysts, which require a non-copper support. This increase in chlorine storage capacity can then translate into improved dichlorine production efficiency for a given weight of the rare-earth catalyst.

For the various embodiments, the rare-earth catalysts of the present disclosure can be formed into a pellet, an extrudate or other formed shape that could be used in a packed bed or fixed bed reactor to operate in pressure swing or cyclic mode, as discussed herein. In additional embodiments, the rare-earth catalysts of the present disclosure can be formed into a fluidizable material, such as through a spray-drying process, having a particle size distribution that is commensurate with being conveyed pneumatically in a riser or regenerator moving bed type system. Examples of such forms include, but are not limited to Geldart powders, where a Geldart B powder is preferred.

The rare-earth catalyst based on Lanthanides should be able to operate at temperatures above those of even where the copper chlorides liquefy, thus potentially accessing higher kinetic rates while reducing expensive metal loss from the system. Temperatures of operation can potentially range up to the melting point of the rare-earth catalyst. For example, temperatures of operation when using lanthanum trichloride (LaCl₃) can be up to 827° C. Preferably, however, temperatures of operation when using lanthanum trichloride are from 327° C. to 727° C.

For the various embodiments, reacting the rare-earth metal oxy-chloride with HCl during the chlorination stage (A) of the process can occur at a first temperature preferably in a range of 100° C. to 500° C., more preferably in a range of 300° C. to 450° C., and most preferred in a range of 350° C. to 450° C. For the various embodiments, the reaction pressure for the chlorination stage (A) of the process can be in a range from 100 kPa to 20000 KPa, more preferably from 150 KPa to 10000 KPa and most preferably from 200 KPa to 5000 KPa.

For the various embodiments, a distinct advantage to the process of the present disclosure is that the process for producing dichlorine does not require the HCl and H₂O to be separated either before and/or after the chlorination stage (A), which may be problematic due to the fact that HCl and H₂O can form an azeotrope. In fact, it is possible to supply HCl during the chlorination stage (A) of the reaction having up to 80 weight percent water as the presence of water at this stage is not necessarily problematic to the production of dichlorine. In this manner, the azeotropic composition of HCl/H₂O can be broken, and dichlorine can be produced.

For the various embodiments, reacting the rare-earth metal chloride with oxygen during the oxidation stage (B) of the process can occur at a second temperature preferably in a range of 500° C. to 827° C., more preferably in a range of 550° C. to 800° C., and most preferred in a range of 600° C. to 750° C. For the various embodiments, the reaction pressure for the oxidation stage (B) of the process can be in a range from 100 kPa to 20000 KPa, more preferably from 150 KPa to 10000 KPa and most preferably from 200 KPa to 5000 KPa.

During the oxidation stage (B), purge gas can be used to liberate the dichloride. For the various embodiments, the purge gas can include oxygen (O₂), which can be supplied as a pure gas (i.e., as pure oxygen) and/or can be included with inert gases, such as CO₂ and N₂, among others. Separating the dichloride from the purge gas can then be accomplished through the use of one or more condensers. For the various embodiments, the dichlorine produced in the oxidation stage (B) is “dry,” meaning that the dichlorine has less than 1 wt % water, more preferably the dichlorine has less than 0.5 wt % water, and most preferably the dichlorine produced in the oxidation stage (B) has less than 0.1 wt % water.

For the various embodiments, the process and the system of the present disclosure produces the dichlorine can use the chlorination stage (A) and the oxidation stage (B) to decouple the chemistry of the Deacon reaction. For the various embodiments, the two-stages can be conducted in either a single reactor or in a reactor having two or more reactors. Decoupling the Deacon reaction according to the present disclosure allows for the equilibrium constraints of the Deacon reaction to be overcome, allowing for a higher conversion of the hydrochloric acid to dichlorine as compared to the traditional Deacon reaction while utilizing a low volatility solid material to limit catalyst loss.

For the various embodiments, the two-stage process can produce dichloride from HCl. As indicated by the reaction of the chlorination stage (A), above, water is produced in addition to the rare-earth metal chloride. For the various embodiments, the water produced in the chlorination stage (A) can be separated from the rare-earth metal chloride prior to the oxidation stage (B) of the reactions. Separating the water and the HCl from the rare-earth metal chloride prior to the oxidation stage (B) reaction to produce the dichlorine can eliminate the need for a high energy distillation of the water/HCl azeotrope. Unlike the traditional Deacon reaction, the process of the present disclosure envisions no prior separation of the HCl/water in the chlorination stage (A), only that the rare-earth metal chloride be separated from the HCl/water prior to oxidation stage (B). Moreover, the thermodynamics of the chlorination stage (A) reaction suggests that HCl can be “dried” using the rare-earth metal oxy-chloride under the correct conditions. This may provide a methodology to break the HCl/water azeotrope if desired.

For the various embodiments, using the rare-earth catalysts in the embodiments of the present disclosure allows for a wide range of operating conditions, as discussed herein, to be used in the two-stage process for converting a stream of HCl to dichlorine. For the various embodiments, the two-stage process of the present disclosure can be implemented in a variety of systems for producing dichloride. Examples of such systems include, but are not limited to, fixed bed reactor(s) operating in temperature and/or pressure swing modes and/or fluidized bed reactors that allow for switching of feed composition, changing of reactor pressures and/or changing of reactor temperatures for the stages of the overall reaction. Embodiments of the present disclosure also include the use of two or more reactors to be used, where the environment, temperature, and pressure of each reactor can be controlled to accomplish the two-stage process of the present disclosure. For the various embodiments, it is also possible that the two or more reactors can be interconnected so as to allow the rare-earth catalyst to be transported between reactors during the two-stage process.

Referring now to FIG. 1, there is shown an embodiment of a system 100 for the production of dichlorine according to the present disclosure. As illustrated, the system 100 includes a chlorination reactor 102 and an oxidation reactor 104. For the various embodiments, the chlorination reactor 102 and the oxidation reactor 104 can each be a moving fluidized bed reactor.

For the various embodiments, the chlorination reactor 102 includes a first inlet 106 and a first outlet 108. For the various embodiments, the oxidation reactor 104 includes a second inlet 110 and a second outlet 112. The chlorination reactor 102 and the oxidation reactor 104 also include the rare-earth catalyst 114, as discussed herein. For the various embodiments, the rare-earth catalyst 114 can be present in form of both the rare-earth metal oxy-chloride and the rare-earth metal chloride along the length of the reactor. For example, the rare-earth catalyst 114 can be present in more of the rare-earth metal oxy-chloride state near the first inlet 106 of the chlorination reactor 102 and more in the rare-earth metal chloride state closer to the first outlet 108. Similarly, the rare-earth catalyst 114 can be present in more of the rare-earth metal chloride state near the second inlet 110 of the oxidation reactor 104 and more in the rare-earth metal oxy-chloride state closer to the second outlet 112.

For the various embodiments, during the chlorination stage (A) reaction in the chlorination reactor 102, hydrochloric acid can be pumped to move between the first inlet 106 and the first outlet 108 of the chlorination reactor 102. For the various embodiments, the hydrochloric acid passing over the rare-earth metal oxy-chloride in the chlorination stage reacts with the rare-earth metal oxy-chloride at the first temperature, as discussed herein, to form the rare-earth metal chloride and water. For the various embodiments, the un-reacted hydrochloric acid and water can then exit the chlorination reactor 102 via the first outlet 108. As discussed herein, the un-reacted hydrochloric acid and water need not be separated for the system 100 to be able to produce dichlorine. Additionally, it is possible to return the un-reacted hydrochloric acid and the water back into the chlorination reactor 102 via the first inlet 106. It may also be desirable to remove some of the water before recycle through normal condensation methods. As appreciated, when the un-reacted hydrochloric acid and the water are returned to the chlorination reactor 102 via the first inlet 106 additional hydrochloric acid can be added to the stream to better ensure proper reaction stoichiometry exists in the chlorination reactor 102.

For the various embodiments, during the oxidation stage (B) reaction in the oxidation reactor 104, oxygen can be pumped to move between the second inlet 110 and the second outlet 112 of the oxidation reactor 104. For the various embodiments, the oxygen passing the rare-earth metal chloride in the oxidation stage reacts with the rare-earth metal chloride at the second temperature, as discussed herein, to form a rare-earth metal oxy-chloride and dichlorine. For the various embodiments, the dichlorine and un-reacted oxygen can then exit the oxidation reactor 104 via the second outlet 112. For the various embodiments, the dichlorine can be separated from the oxygen through the use, among other techniques, of one or more compressors.

For the various embodiments, the rare-earth catalyst 114 in its different states can be moved between the chlorination reactor 102 and the oxidation reactor 104, and between the oxidation reactor 104 and the chlorination reactor 102, through the use of a conduit 116 connecting the chlorination reactor 102 and the oxidation reactor 104. So, for example, the rare-earth metal chloride from the chlorination reactor 102 moves through the conduit 116 to the oxidation reactor 104. As discussed herein, the rare-earth metal chloride enters the oxidation reactor 104 near the second inlet 110 of the oxidation reactor 104. Closer to the second outlet 112 of the oxidation reactor 104, the rare-earth metal oxy-chloride can then be moved via the conduit 116 to enter the chlorination reactor 102 near the first inlet 106. For the various embodiments, the rare-earth catalyst 114 can be moved through the conduit 116 via a number of different modes of physical transport. Examples of such modes of physical transport include, but are not limited to, a conveyer belt or most preferably through pneumatic means by differential pressure.

For the various embodiments, the system 100 can further include a purge system 118. For the various embodiments, the purge system 118 can be located at one or more points within the chlorination reactor 102 and/or along the conduit 116 connecting the chlorination reactor 102 and the oxidation reactor 104. For example, the purge system 118 could be located along the conduit 116, as discussed herein. The purge system 118 could also be located at a disengagement zone within the chlorination reactor 102 in and/or around the area where the rare-earth metal chloride moves from the reactor 102 to the conduit 116. For example, this disengagement zone in the chlorination reactor 102 could include a cyclone that could mix with a purge gas to help move the water and unreacted hydrochloric acid through the first outlet 108, while the rare-earth metal chloride moves to the conduit 116. It is also possible that the purge system 118 could be provided in a separate reactor attached to the chlorination reactor 102, in which the water and unreacted hydrochloric acid could be purged from the rare-earth metal chloride prior to it moving through the conduit 116 to the oxidation reactor 104.

For the various embodiments, when the purge system 118 is located along the conduit 116, it purges water and unreacted hydrochloric acid from the rare-earth metal chloride coming from the chlorination reactor 102 and/or moving through the conduit 116 from the chlorination reactor 102 to the oxidation reactor 104. For the various embodiments, the purge system 118 can either pump inert gas counter current to the direction of the rare-earth metal chloride moving from the chlorination reactor 102 through the conduit 116 to the oxidation reactor 104, or the inert purge gas could flow co-current to the solid flow to facilitate the pneumatic transport of the solid from the chlorination reactor 102 to the oxidation reactor 104. If a purge system 118 is to be used, extra purge gas inlets and outlets leading from 118 could be necessary. The inlet to 118 would contain the dry purge gas, while the outlet to 118 would contain water and unreacted HCl. Gas cyclones or other solid/gas disengagement devices could be employed as necessary.

Embodiments of the system 100 also include a heated section 120 associated with each of the chlorinator reactor 102 and the oxidizer reactor 104. For the various embodiments, the heated section 120 can be used to achieve and maintain the first temperature during the chlorination stage reaction in the chlorination reactor 102, and the second temperature during the oxidation stage reaction in the oxidation reactor 104. For the various embodiments, the gasses entering the first inlet 106 and the second inlet 110 can also provide heat to achieve and maintain either the first temperature and/or the second temperature used in the system 100. The heated section 120 could be designed as appropriate to those skilled in the art as to operate on steam, a heat transfer oil, or direct natural gas combustion. As discussed herein, the chlorination reactor 102 and the oxidation reactor 104 can be operated at a pressure of 100 kPa to 20000 kPa.

As discussed herein, an example of a suitable rare-earth metal catalyst is lanthanum (La). For the system 100, lanthanum oxychloride can be fluidized and reacted with either anhydrous HCl or vaporized aqueous HCl in the chlorination reactor 102 to yield lanthanum trichloride. During the reaction, water would be formed from the reacted solid and removed from chlorination reactor 102. The lanthanum trichloride would then be transported to the oxidation reactor 104, which is operating at a higher temperature than the chlorination reactor 102 and in the presence of oxygen. Inert gas stripping and/or a desiccant are then used in the purge system 118 along the conduit 116 from the chlorination reactor 102 to the oxidation reactor 104 to help remove water and hydrochloric acid from the rare-earth metal chloride moving through the conduit 116. Preferably, the rare-earth metal chloride entering the oxidation reactor 104 has a water content (in gas or solid phase) that will not increase the water content of the dichlorine generation in the oxidation reactor to more than 0.1 weight percent. The lanthanum trichloride having been dried then enters the oxidation reactor 104 where it reacts with oxygen to yield lanthanum oxychloride and liberate dichlorine. The lanthanum oxychloride would then be moved from the oxidation reactor 104 back to the chlorination reactor 102, and the cycle continues.

Referring now to FIG. 2, there is shown an alternative embodiment of a system 200 for the production of dichlorine according to the present disclosure. As illustrated, the system 200 includes a reactor 230 containing the rare-earth catalyst 214. For the various embodiments, the reactor 230 can be a fixed bed reactor that operates in a temperature and/or pressure swing mode or a fluidized bed reactor, either of which could have one or more beds. For the various embodiments, the reactor 230 includes an inlet 232 and an outlet 234 for exchanging the reaction gases used in performing the chlorination stage (A) and the oxidation stage (B) of the present disclosure. The reactor 230 also includes a heater 236, which allows for changing the temperature of the rare-earth catalyst 214 in the reactor 230 between the first temperature used in the chlorination stage (A) reaction and the second temperature used in the oxidation stage (B) reaction, as discussed herein.

By way of example, the system 200, used as a single bed reactor, can contain the rare-earth catalyst 214 in the oxidized state (e.g., LaOCl). The inlet 232 and outlet 234 can be used to introduce an environment of HCl and water to the reactor 230, which can be heated to first temperature during the chlorination reaction. Upon sufficient time to form the chlorided state of the rare-earth catalyst 214 (e.g., LaCl₃), the HCl and water environment could be exchanged via the inlet 232 and outlet 234 for an oxygen environment. For the various embodiments, exchanging the environment can be sufficiently complete to ensure that the environment surrounding the chlorided state of the rare-earth catalyst (e.g., LaCl₃) is dry, as defined herein. In addition to exchanging the environment, the temperature of the rare-earth catalyst 214 can be increased to the second temperature during the oxidation reaction. Upon sufficient time to form the oxidized state of the rare-earth catalyst (e.g., LaOCl), the liberated dichlorine can be removed from the reactor 230. The temperature can be returned to the first temperature along with HCl and water being reintroduced into the reactor 230.

In an additional embodiment, when the reactor 230 includes two or more beds the oxidation stage (B) reaction can be occurring in a predetermined number of the two or more beds (e.g., one of the two beds) while the chlorination stage (A) reaction is occurring in the remaining number of the two or more beds. The environments of the beds can then be exchanged to allow for a semi-continuous process for producing dichlorine to be achieved.

The use of rare-earth catalysts in the embodiments of the present disclosure may also allow for more efficient reactor cleaning and/or catalyst reloading of a reactor. For example, lanthanum trichloride is water soluble, which would allow for this form of the rare-earth catalysts used in the embodiments of the present disclosure to be rinsed and/or washed from the reactor through the use of an aqueous based solution (e.g., water). In this way, a deactivated catalyst might be removed from the reactor system, or the catalyst could be removed for reactor maintenance. It is possible to recycle this now solubilzed lanthanum chloride solution for the preparation of new lanthanum based catalysts for use in this process.

The following examples are illustrative of the present disclosure, but are not to be construed as to limit the scope in any manner.

### Examples

### Example 1

### Chlorination of Lanthanum Oxychloride

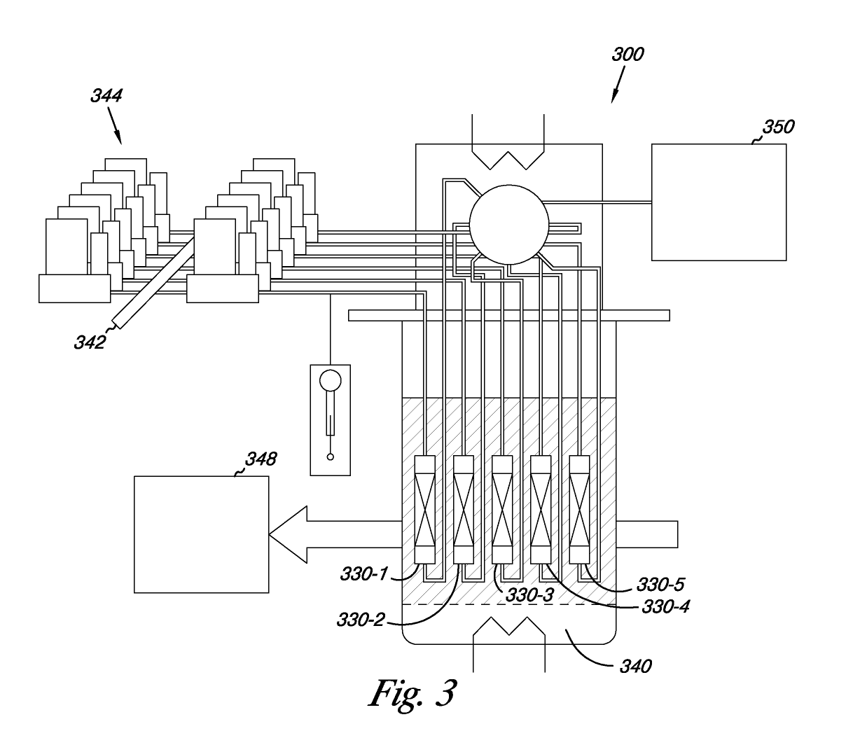

A system 300 for the chlorination of lanthanum oxychloride is shown in FIG. 3. The system includes five reactors 330-1 through 330-5, each being constructed from 1/4-inch 316 stainless steel tubing with catalyst bed lengths of at least 10 cm. The typical size range of the catalyst particles is 20 to 40 mesh. These particles give a negligible pressure drop (1 psi) at 100 sccm flow through a 1/8-inch reactor.

To ensure uniform reactor wall temperatures, a fluidized sand bath heater 340 is used. The heater 340 is a Techne SBL-2D, capable of operation up to 600° C. A constant expanded bed height is maintained by adjusting the flow rate of the fluidizing air. The temperature in the sand bath heater 340 is monitored at three different locations. Two thermocouples are located at similar heights but different radial positions (about 5 cm apart from each other). A third thermocouple monitors the temperature of the sand in the zone near the heaters. The sand bath heater 340 media is Al₂O₃, with a mean particle size of roughly 125 μm. The reaction gas mixture from a common manifold 342 is fed to all five reactors 330-1 through 330-5.

The manifold 342 composition is set by adjusting the set points of the feed component Brooks 4850 mass flow controllers 344 (He, HCl, O₂, or Cl₂). A ball valve downstream of each component mass flow controller is closed (or switched to N₂ purge if HCl or Cl₂) when a given component is not included in the feed mixture. Each reactor mass flow controller is downstream of a 3-way ball valve that selects either the manifold mixture or nitrogen. The HCl, Cl₂, and reactor flow controllers are continually purged when inactive to prevent corrosion of the mass flow controller internals, which will occur if the internals of these devices are exposed to ambient air. The sum of the component feed rates is set in excess of the sum of the reactor feed rates. The excess flow (typically) is sent to the “bypass” mass flow controller, which is used to maintain a fixed manifold pressure (typically 20 to 60 psig). This bypass stream is periodically sampled to check the feed composition or to update the analytical response factors of the feed components.

All streams that exit the process are treated in two sequential scrubbers. The first scrubber contains about 4 liters of DI water that is continually recycled until the concentration of HCl approaches 10 weight percent (based on HCl fed to the system), or about 12 moles of HCl. At a typical total HCl feed rate of 20 sccm, the required frequency of changing the scrubber water is only once per 9 days. The second scrubber contains about 12 liters of a caustic solution. This scrubber is changed only as needed based on the quantity of Cl₂ fed to the system.

The process control and data acquisition 348 are automated using Camile TG™. The system 300 is designed for continuous, unattended operation. Several macros are used to monitor critical process parameters, systematically vary process parameters, and perform other routine tasks.

Gas-phase analysis of the product stream is performed by a ThermoFinnigan GC/MS 350. This system included a GCTop8000 gas chromatograph from CEInstruments, a Voyager™ mass spectrometer, and a Digital personal computer. The quadrupole mass spectrometer is operated at 70 eV EI in full scan-mode with unit resolution. The scan speed of the mass spectrometer is set such that 12-16 full scans across a spectral range of m/z 10 to 200 could be recorded across each chromatographic peak. A GS-GasPro column (30 m long, 0.32 mm inner diameter, J&W Scientific part number 113-4332) was used for analysis.

Four samples of the LaOCl catalysts are prepared, where each has initial composition as documented in Table 1. The four samples follow the general precipitation procedure outlined below for a first sample, referred to as LaOCl-1. Three of the four samples of LaOCl (LaOCl-1, LaOCl-2, and LaOCl-3) are prepared from a rare-earth chloride ore containing pure lanthanum with less than 1 percent of trace elements (Mg, Al, and Si). The fourth sample, LaOCl-4, is prepared by calcination of anhydrous LaCl₃ (Sigma-Adrich).

LaOCl-1 is prepared from a rare-earth chloride ore containing 74/9/3/14 La/Ce/Nd/Pr by rare-earth weight fraction. 15 grams of the ore (˜0.0404 moles) is dissolved in 150 mL of deionized water. Upon addition of 20 ml of 6M ammonium hydroxide (˜0.121 moles), a gelatinous participate is formed. The precipitate is recovered by centrifugation, and resuspended for washing in 100 ml of deionized water. After the solid is again recovered by centrifugation, the wet cake is transferred to a porcelain dish heated at 4° C./min to a final temperature of 550° C. in air. The temperature was held at 550° C. for four hours. At the end of four hours, the oven would turn off and cool, again under air atmosphere. The solid was then sieved to 20x40 mesh particles for reactor testing.

Neutron Activation Analysis (NAA) analyses the La and Cl composition of the LaOCl-1. For analysis, duplicate samples are prepared by transferring approximately 50 mg of material into pre-cleaned 2-dram polyethylene vials. Duplicate standards of La and Cl are prepared from their standard solutions into (obtained from NIST certified, SPEX CertiPrep) similar vials. The samples are dissolved and diluted to appropriate volumes using pure water and HNO₃. The samples and standards vials are then heat-sealed. They are then analyzed following the standard NAA procedure. Specifically, irradiation is performed for 2 minutes at 250 kW nuclear reactor power. The waiting time is 9 minutes and the counting time is 270 seconds using an HPGe detector set. Concentrations are calculated using Canberra software and comparative technique. The results of the analysis are shown in Table 1.

TABLE 1
Neutron Activation Analysis for LaOCl Catalyst precursors and Catalysts before
and after Temperature Programmed Oxidation (TPO) treatments.

| | Catalyst Precursor Before | | | Composition by HCL | | | | | |
|---|---|---|---|---|---|---|---|---|---|
| | Activation | | | conversion after activation | | | Catalyst after TPO | | |
| | La | Cl | Cl/La | La | Cl | Cl/La | La | Cl | Cl/La |
| Catalyst | (mol. %) | (mol. %) | (mol) | (mol. %) | (mol. %) | (mol) | (mol. %) | (mol. %) | (mol) |
| LaOCl-1 | 27 ± 0.2 | 16 ± 0.2 | 0.59 ± 0.01 | 56.7 | 43.3 | 3.0 | ND | ND | ND |
| LaOCl-2 | 74.8 ± 0.7 | 13.7 ± 0.3 | 0.72 ± 0.02 | ND | ND | ND | 56 | 13 | 2.3 |
| LaOCl-3, | 72.4 ± 0.5 | 10.1 ± 0.2 | 0.58 ± 0.01 | ND | ND | ND | 59.3 | 20.2 | 1.33 |
| 20% O₂ | | | | | | | | | |
| LaOCl-3, | 72.4 ± 0.5 | 10.1 ± 0.2 | 0.58 ± 0.01 | ND | ND | ND | 68 ± 1 | 18 ± 1 | 1 ± 0.1 |
| 17% O₂ | | | | | | | | | |
| LaOCl-4 | ND | ND | ND | ND | ND | ND | ND | ND | ND |

ND—Not Determined

Approximately 2.8 grams of LaOCl-1 was load into each of the 5 reactor tubes 330-1 through 330-5 and is chlorinated at 400° C. with HCl or HCl/O₂ using the following treatments:
Reactor 330-1 was fed 20 sccm of 4/1/1 He/HCl/O₂ for 5 hours.
Reactor 330-2 was fed 20 sccm of 4/1/1 He/HCl/O₂ for 9 hours.
Reactor 330-3 was fed 20 sccm of 5/1 He/HCl for 2 hours.
Reactor 330-4 was fed 20 sccm of 5/1 He/HCl for 5 hours.
Reactor 330-5 was fed 20 sccm of 5/1 He/HCl for 16 hours.

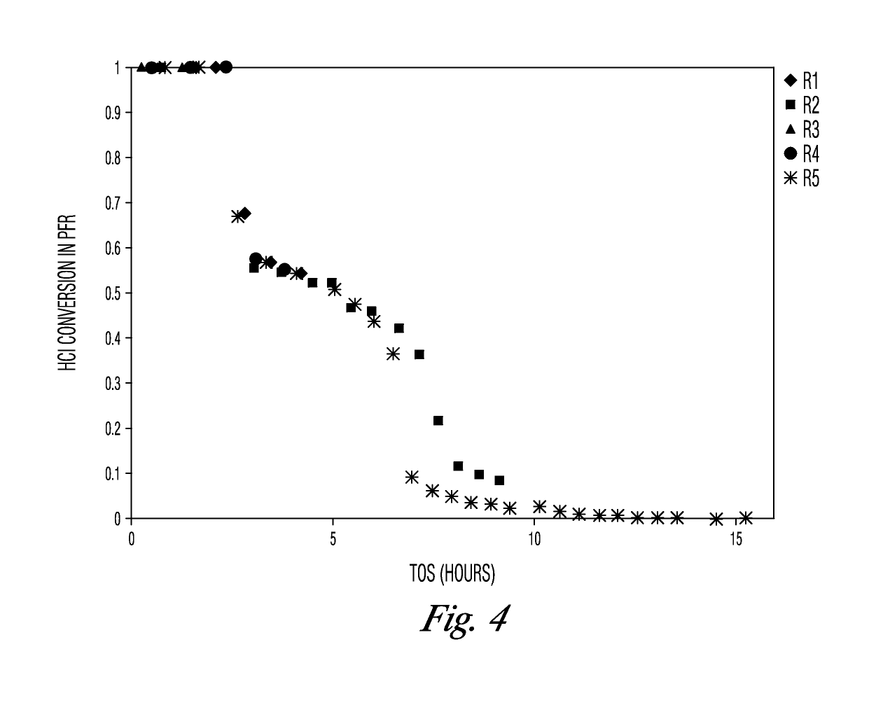

The HCl conversion in each reaction is monitored as function of time, and in FIG. 4 plotted versus time. The assumed reaction is as follows:

LaOCl(or(RE)OCl)+2HCl→LaCl₃+H₂O

(where RE represents the combined rare earths of La, Ce, Nd and Pr present in the rare-earth chloride ore)

For all 5 samples, HCl breakthrough did not occur until after 2.5 to 3 hours. Based on the initial catalyst composition of LaCe_{0.12}Nd_{0.04}Pr_{0.18}O_{1.73}Cl_{0.59}=(RE)O_{1.28}Cl_{0.44}, this breakthrough corresponds to an average catalyst composition near (RE)O_{0.5}Cl₂.

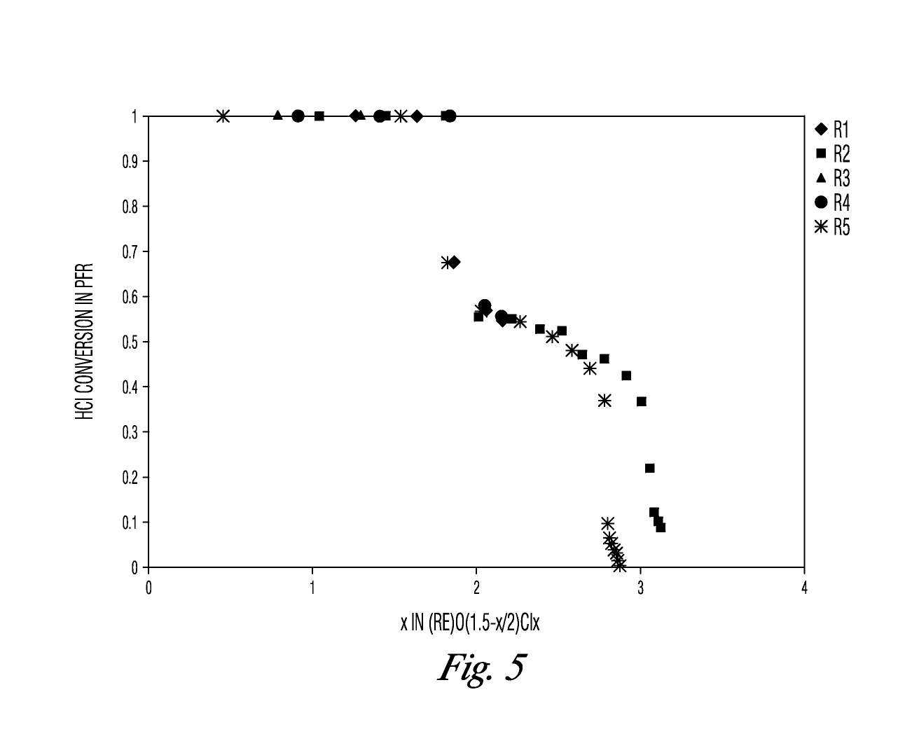

The same HCl conversion data are plotted versus the average Cl content of the catalyst in FIG. 5. The x-axis was obtained by integration of the HCl conversion data. These data clearly show a sudden breakthrough of HCl once the solid phase has achieved about 2 Cl atoms per rare earth atom. Incorporation of Cl into the catalyst becomes slower beyond that point, resulting in fractional conversions of HCl that approach 0% as the final (RE)Cl₃ composition is reached.

### Example 2

### Dechlorination of Lanthanum Trichloride to form Dichlorine

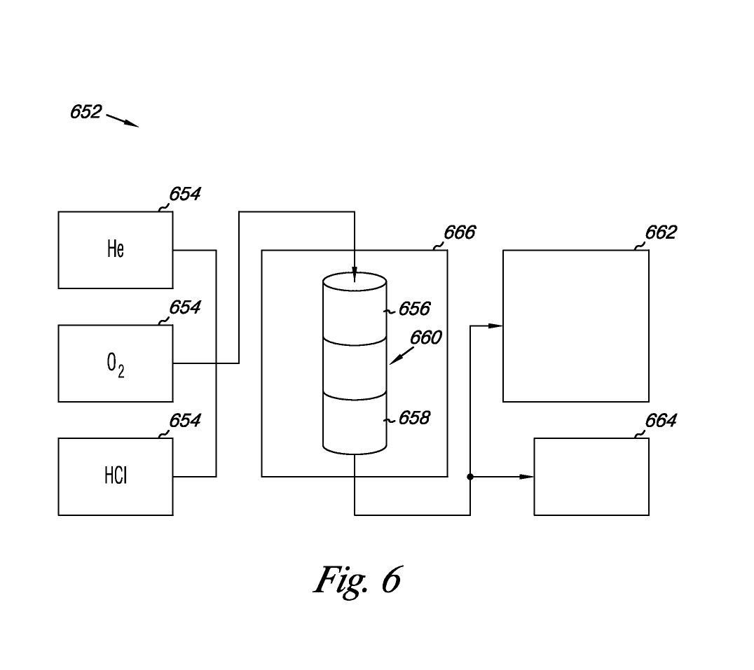

FIG. 6 provides a reactor 652 schematic used in temperature-programmed oxidation (TPO) experiments to make dichlorine. The reactor 652 includes an RXM-100 instrument (Advanced Scientific Design, Inc.) having a modified set-up for chlorination chemistry. The modified set-up consisted of a set of mass flow controllers (MFCs, Brooks 4850) 654, a 4 mm ID U-shaped quartz tube reactor 656 with a larger 15 mm glass frit section 658 to hold the catalyst 660, a mass spectrometer (UTI, Precision Gas Analyzer, Model 100C) 662, and a scrubber system 664 which passed the outlet gas from the reactor 652 through a fritted glass contactor containing 2M sodium hydroxide.

A desired catalyst charge 660 is placed on top of the glass frit section 658. A furnace 666 capable of achieving temperatures above 800° C. encloses the U-shaped reactor 656. Nickel tubing is used for all plumbing in the reactor 652, and all tubing after the reactor 652 is heated by heat tape to at least 120° C. in an attempt to avoid the corrosive effects of HCl in condensed H₂O. A stainless tee containing a small capillary leak and maintained at a temperature of 200-250° C. diverts a slipstream of the reactor 652 effluent to the mass spectrometer 662. Pressure in the mass spectrometer chamber is typically high, around 8×10−5 Torr. The mass spectrometer chamber is run at 120° C. to limit corrosion. For HCl, a mass-to-charge ratio of 28 is monitored, for oxygen mass-to-charge 32, while for dichlorine mass-to-charge ratios of 70, 72, and 74 are monitored.

For the production of dichlorine during a temperature programmed oxidation experiment, an amount of catalyst is charged to the top of the glass frit section 658. The amount of catalyst charged, and the initial surface area as determined by N₂ BET experiment is shown in Table 2. The LaOCl is loaded as 20X40 mesh particles by weight as calcined, and therefore loaded as primarily LaOCl. Before each TPO experiment, the catalyst is activated (converted to LaCl₃) in a stream of 20 vol % HCl in helium at 30 standard cubic centimeters per minute (sccm) and 400° C. for 3.25 hours. After activation, HCl is removed, and the activated catalyst is cooled in He to 30° C. over the course of about one-hour. Oxygen flow at 20 vol % (unless otherwise specified) in He at 30 sccm total flow is started at 30° C. A portion of the reactor effluent is then diverted to the mass spectrometer 660 via the tee. A temperature ramp of 10° C./min is employed until 700° C., after which the temperature is held isothermally at 700° C. for several minutes until the experiment was terminated. During this temperature ramp, dichlorine evolution is monitored by mass spectrometry 660 according the presumed reaction:

2LaCl₃+O₂→2LaOCl+2Cl₂

TABLE 2
Catalyst charge and surface are of LaOCl materials for TPO experiments

| | Amount | BET Surface Area |
|---|---|---|
| Catalyst | Tested (g) | (m²/g) |
| LaOCl-2 | 0.729 | 36 |
| LaOCl-3, 20% O₂ | 0.708 | 20 |
| LaOCl-3, 17% O₂ | 0.726 | 20 |
| LaOCl-4 | 0.723 | 9 |

After the completion of the experiment, oxygen flow is stopped, and the catalyst is inerted and cooled to ambient temperature in helium. The reactor tube is then quickly transferred to an inert atmosphere glove box through air, and the catalyst is removed and stored inertly for subsequent compositional analysis by neutron activation. The neutron activation analysis of the samples dichlorinated in the TPO experiments is found in Table 1.

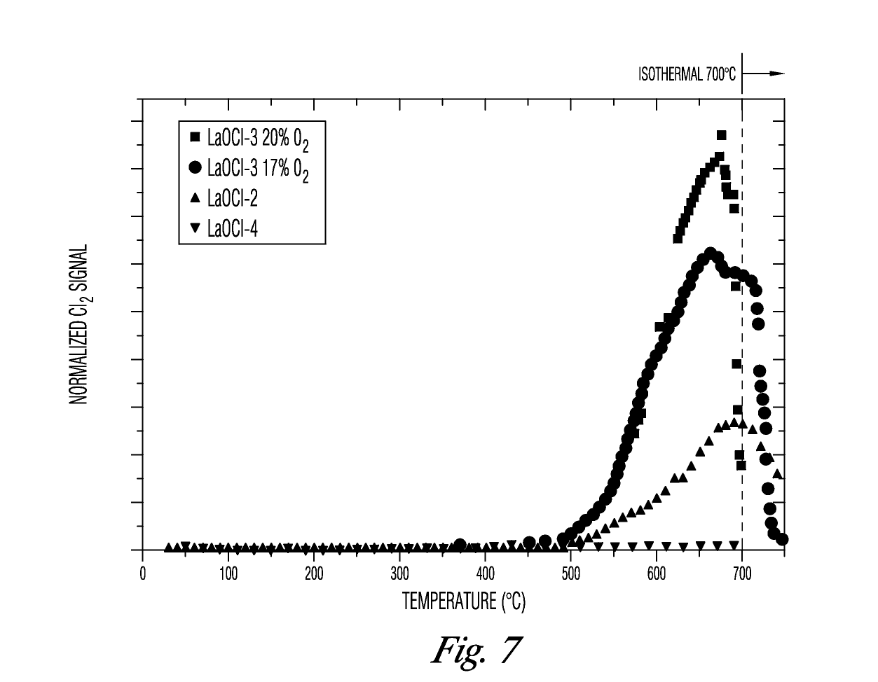

FIG. 7 provides the normalized mass spectral signal for dichlorine evolution results from the TPO of the catalysts listed in Table 2 as a function of temperature. To provide a fair basis of comparison and correct for potential differences in signal intensity between analyses, the activated material was assumed to be bulk LaCl₃. The mass spectrometer signal from dichlorine evolution at a mass-to-charge signal of 70 mass-to-charge ratio was integrated and divided by amount of chlorine lost per the neutron activation data. This created a response factor with which to calculate the normalized levels of dichlorine produced for a given signal intensity.

The results for FIG. 7 and Table 1 show that at temperature above 400° C. dichlorine can be produced from activated lanthanum trichloride (molar ratio Cl/La˜3) resulting in the conversion of the material back to lanthanum oxychloride (molar ratio Cl/La˜1).

What is claimed is:

1. A process for producing dichlorine (Cl₂), comprising:
reacting a rare-earth metal oxy-chloride catalyst having no support with HCl at a first temperature during a chlorination stage of the process to form rare-earth metal chloride and H₂O;
removing unreacted HCl from the rare-earth metal chloride;
removing H₂O from the rare-earth metal chloride; and
reacting the rare-earth metal chloride with O₂ at a second temperature greater than the first temperature, wherein the second temperature is in a range of 500° C. to 827° C. during an oxidation stage of the process to form Cl₂ and the rare-earth metal oxy-chloride catalyst.

2. The process of claim 1, where the rare-earth metal oxy-chloride catalyst is LaOCl and the rare-earth metal chloride is LaCl₃.

3. The process of claim 1, where removing H₂O from the rare-earth metal chloride includes purging the rare-earth metal chloride with an inert gas to remove the H₂O.

4. The process of claim 1, including passing the HCl over the rare-earth metal oxy-chloride catalyst in the chlorination stage and passing the O₂ over the rare-earth metal chloride in the oxidation stage.

5. The process of claim 4, including conveying the rare-earth metal chloride from the chlorination stage to the oxidation stage; and
conveying the rare-earth metal oxy-chloride catalyst from the oxidation stage to the chlorination stage.

6. The process of claim 1, including maintaining the rare-earth metal oxy-chloride catalyst and the rare-earth metal chloride in a solid non-liquid state.

7. The process of claim 1, including removing substantially all H₂O from the rare-earth metal chloride, and where reacting the rare-earth metal oxy-chloride catalyst with HCl includes supplying HCl having up to 80 weight percent water.

8. The process of claim 1, where reacting the rare-earth metal chloride with O₂ forms Cl₂ having less than 0.1 weight percent water.

9. The process of claim 1, where the rare-earth metal chloride do not include copper or ruthenium.

10. The process of claim 1, where unreacted HCl is removed from rare-earth metal chloride prior reacting the rare-earth metal chloride with the O₂.

11. The process of claim 10, including removing all unreacted HCl from the rare-earth metal chloride such that no HCl is present when reacting the rare-earth metal chloride with O₂.

12. The process of claim 1, where the rare-earth metal oxy-chloride catalyst does not include copper or ruthenium.

13. The process of claim 1, including reacting the rare-earth metal oxy-chloride having no support with the HCl at the first temperature during the chlorination stage of the process to form the rare-earth metal chloride and the H₂O.
